(19) United States
(12) Patent Application Publication
(10) Pub. No.: US 2012/0261480 A1
(43) Pub. Date: Oct. 18, 2012

(54) TEMPERATURE CONTROL SYSTEM

(75) Inventor: CAI-JIN YUAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/233,859

(22) Filed: Sep. 15, 2011

(30) Foreign Application Priority Data
Apr. 18, 2011 (CN) 201110096200.8

(51) Int. Cl. G05D 23/00

(52) U.S. Cl. 236/51

(57) ABSTRACT

A temperature control system includes a plurality of temperature sensors, a main controller, a plurality of power supply controllers, and a plurality of cooling devices. The temperature sensors measure current temperature of different monitored areas. The main controller compares the current temperature of the monitored areas with a predetermined temperature stored in the main controller. The power supply controller is selectably turned on or off according to the comparison to activate or deactivate the corresponding cooling devices under the control of the power supply controller.

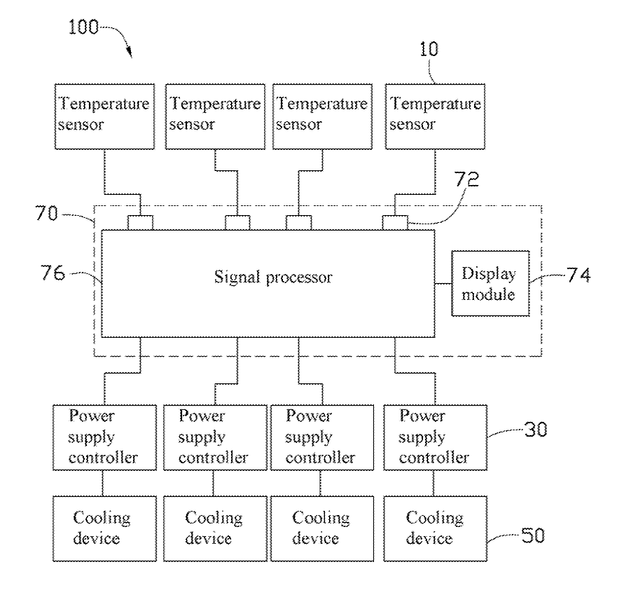

### BACKGROUND

1. Technical Field

The disclosure generally relates to control systems, and particularly to a temperature control system.

2. Description of the Related Art

Container data centers (CDCs) usually include servers, network equipment, storage devices, power supplies, or other electronic components. These electronic components are sealed or received within a metal container, and will generate lots of heat when working. However, the heat may not be immediately dispersed from the container, which may result in overheating in the container, which could affect the normal operation of these electronic components. In addition, the temperature in the container cannot be automatically adjusted according to the surrounding environment temperature.

Therefore, there is room for improvement within the art.

### BRIEF DESCRIPTION OF THE DRAWINGS

Many aspects of a temperature control system can be better understood with reference to the following drawings. The components in the drawings are not necessarily drawn to scale, the emphasis instead being placed upon clearly illustrating the principles of the temperature control system. Moreover, in the drawings, like reference numerals designate corresponding parts throughout the several views. Wherever possible, the same reference numbers are used throughout the drawings to refer to the same or like elements of an embodiment.

The drawing is a block view of a temperature control system, according to an embodiment of the disclosure.

### DETAILED DESCRIPTION

The drawing is a block view of a temperature control system 100, according to an embodiment of the disclosure. The temperature control system 100 can be used in a container data center (CDC), an equipment room, or an internet data center, for example, to automatically adjust and regulate the temperature. In this embodiment, the CDC that usually include servers, network equipment, storage devices, and power supplies is taken here as an example to illustrate the temperature control system 100.

The temperature control system 100 includes a plurality of temperature sensors 10, a plurality of power supply controllers 30, a plurality of cooling devices 50, and a main controller 70. The main controller 70 is electrically connected to the plurality of temperature sensors 10 and the plurality of power supply controllers 30. Each of the plurality of cooling devices 50 corresponds to one of the power supply controllers 30, and is electrically connected to the main controller 70 through the corresponding power supply controller 30.

The plurality of temperature sensors 10 are capable of measuring temperature parameters in the CDC and converting the measured temperature parameters into a signal which can be read by an observer or by an instrument. In this embodiment, the number of temperature sensors 10 is four, which are arranged within the CDC and are substantially adjacent to high-power electronic equipment such as servers. The CDC is divided into corresponding monitored areas by the plurality of temperature sensors 10. Each temperature sensor 10 gathers and measures the temperature parameters in its monitored area. The temperature sensor 10 further converts the measured temperature parameters into a corresponding analog signal, and transmits the converted analog signal to the main controller 70.

Each power supply controller 30 is electrically connected between the main controller 70 and the corresponding cooling device 50. The power supply controller 30 controls and provides operating voltage for the corresponding cooling device 50 under the control of the main controller 70. In this embodiment, the cooling devices 50 can be gas-based refrigeration systems. When the main controller 70 activates the power supply controllers 30, the power supply controllers 30 provide the operating voltage for the corresponding cooling devices 50 to activate the cooling devices 50, so the cooling devices 50 exchange and disperse heat to reduce the temperature of the CDC. When the power supply controllers 30 are turned off, the corresponding cooling devices 50 are in sleep mode.

The main controller 70 includes a plurality of interfaces 72, a display module 74, and a signal processor 76. The signal processor 76 is electrically connected to the plurality of interfaces 72 and the display module 74. In this embodiment, the plurality of interfaces 72 can be USB interfaces that consist of the hardware and associated circuitry that links one device with another (especially a computer and a hard disk drive or other peripherals). Each interface 72 is electrically connected to the corresponding temperature sensor 10. Thus, the converted analog signal from the temperature sensor 10 is transmitted to the signal processor 76.

The display module 74 can provide a means of input that allows users to manipulate the main controller 70, and a means of output that allows the main controller 70 to indicate the effects of the manipulation of the user. In this embodiment, the display module 74 can be a touch screen, or a touch panel, which can input or preset different temperature values that are used as predetermined temperature of the monitored areas. Moreover, the predetermined temperature values can be selected and be adjusted according to operating requirement, or the working environment.

The signal processor 76 is capable of recording and storing the input temperature values from the display module 74, and converting the analog signals from the temperature sensors 10 into corresponding digital signals that signify current temperature of the corresponding monitored areas. The signal processor 76 is further capable of comparing the current temperature with the predetermined temperature.

For example, when the current temperature of any monitored area that is measured by the temperature sensor 10 exceeds the predetermined temperature stored in the signal processor 76, the signal processor 76 sends a first command signal to the corresponding power supply controller 30 in the monitored area to activate the power supply controller 30. When the current temperature of any monitored area is below the predetermined temperature, the signal processor 76 sends a second command signal to the corresponding power supply controller 30 to turn off the power supply controller 30.

In use, the display module 74 inputs and presets a predetermined temperature value such as 26 Celsius for each monitored area and the predetermined temperature value is stored in the signal processor 76 in the form of digital signals. The temperature sensors 10 gather and measure the temperature parameters of the monitored areas in the CDC, and convert the measured temperature parameters in the analog signals, and transmit the analog signals to the signal processor 76 through the interfaces 72. The signal processor 76 converts the analog signals into corresponding digital signals to generate the current temperature of each monitored area. The signal processor 76 monitors and compares the current temperature with the predetermined temperature in real-time to turn on or off the corresponding power supply controller 30, to further activate or deactivate the corresponding cooling device 50.

For example, when the current temperature of any monitored area exceeds the predetermined temperature, the signal processor 76 sends the first command signal to the corresponding power supply controller 30 to activate the power supply controller 30. Thus, the power supply controller 30 powers and activates the corresponding cooling device 50 to reduce the current temperature of the monitored area. When the current temperature of any monitored area is under the predetermined temperature, the signal processor 76 sends the second command signal to the corresponding power supply controller 30 to deactivate the power supply controller 30. So the corresponding cooling device 50 is deactivated or placed in sleep mode to stop reducing the temperature of the monitored area in the CDC. Thus, not only the local temperature but also the overall temperature in the CDC can be controlled and adjusted in real-time, which can help keep the temperature in the CDC balanced and stable.

In addition, the display module 74 can also input and preset a predetermined temperature range such as 25-28 Celsius for each monitored area and the predetermined temperature range is stored within the signal processor 76. Thus, when the current temperature exceeds the temperature range and is higher than the maximal value (28 Celsius), the signal processor 76 sends the first command signal to turn on the corresponding power supply controller 30. When the current temperature is out of the temperature range and is lower than the minimum temperature (25 Celsius) in the temperature range, the signal processor 76 sends the second command signal to turn off the corresponding power supply control 30.

In summary, in the temperature control system 100 of this disclosure, the temperature sensors 10 are located in different monitored areas, and measure the current temperature within the local monitored area in real-time. The signal processor 76 can monitor and compare the current temperature with its predetermined temperature to select and turn on or off the power supply controller 30 according to comparison result, to further control the corresponding cooling device(s) 50 to adjust the temperature of each monitored area. Thus, not only the local temperature but also the overall temperature in the CDC can be controlled and adjusted in real-time, which can help keep the temperature in the CDC balanced and stable and reduce energy waste and cost.

In the present specification and claims the word “a” or “an” preceding an element does not exclude the presence of a plurality of such elements. Further, the word “comprising” does not exclude the presence of other elements or steps than those listed.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A temperature control system, comprising:
a plurality of temperature sensors for measuring current temperature of different monitored areas;
a main controller electrically connected to the plurality of temperature sensors, the main controller storing a predetermined temperature;
a plurality of power supply controllers electrically connected to the main controller; and
a plurality of cooling devices electrically connected to the main controller via the corresponding power supply controllers, the main controller comparing the current temperature of the monitored areas with the predetermined temperature to selectably activate or deactivate the corresponding power supply controllers according to the comparison to activate or deactivate the corresponding cooling devices.

2. The temperature control system as claimed in claim 1, wherein the temperature sensors gather and measure the temperature parameters in the monitored areas, and convert the temperature parameters into corresponding analog signals, and transmit the analog signals to the main controller.

3. The temperature control system as claimed in claim 1, wherein the plurality of cooling devices are refrigeration systems, and each power supply controller is electrically connected between the main controller and the corresponding cooling device, the power supply controller controls and provides operating voltage for the corresponding cooling device under the control of the main controller.

4. The temperature control system as claimed in claim 3, wherein when the power supply controllers are activated by the main controller, the power supply controllers provide the operating voltage for the corresponding cooling devices to activate the cooling devices, the cooling devices exchange and release heat to reduce the temperature of the monitored areas, when the power supply controllers are turned off, the corresponding cooling devices are in sleep mode.

5. The temperature control system as claimed in claim 2, wherein the main controller comprises a plurality of interfaces, the plurality of interfaces are USB interfaces, and each interface is electrically connected to the corresponding temperature sensor.

6. The temperature control system as claimed in claim 5, wherein the main controller further comprises a display module, the display module is a touch screen or a touch panel and is capable of inputting and presetting the predetermined temperature of the monitored areas.

7. The temperature control system as claimed in claim 6, wherein the main controller further comprises a signal processor electrically connected to the plurality of interfaces and the display module, the signal processor records and stores the predetermined temperature from the display module, and converts the analog signals from the temperature sensors into current temperature values, and compares the current temperature values with the predetermined temperature.

8. The temperature control system as claimed in claim 7, wherein when the current temperature of any monitored area exceeds the predetermined temperature, the signal processor sends a first command signal to the corresponding power supply controller to activate the power supply controller, the power supply controller powers the corresponding cooling device to reduce the current temperature of the monitored area, when the current temperature of any monitored area is under the predetermined temperature, the signal processor sends a second command signal to the corresponding power supply controller to deactivate the power supply controller, the corresponding cooling device is deactivated or placed in sleep mode to stop reducing the temperature of the monitored area.

9. A temperature control system used in a container data center (CDC), comprising:
a plurality of temperature sensors dividing the CDC into corresponding monitored areas, and measuring temperature parameters of the monitored areas, and generating corresponding analog signals;
a main controller electrically connected to the plurality of temperature sensors, the main controller storing a predetermined temperature and generating corresponding current temperature according to the temperature parameters;
a plurality of power supply controllers electrically connected to the main controller; and
a plurality of cooling devices, each cooling device electrically connected to the corresponding power supply controller, wherein the main controller compares the current temperature of each monitored area with the predetermined temperature to selectably turn the corresponding power supply controller on or off according to the comparison, the corresponding cooling device is activated or deactivated under the control of the power supply controller.

10. The temperature control system as claimed in claim 9, wherein the plurality of cooling devices are cooling systems, and each power supply controller is electrically connected between the main controller and the corresponding cooling device, the power supply controller controls and provides operating voltage for the corresponding cooling device under the control of the main controller.

11. The temperature control system as claimed in claim 10, wherein when the power supply controllers are activated by the main controller, the power supply controllers provide the operating voltage for the corresponding cooling devices to activate the cooling devices, the cooling devices exchange and disperse heat to reduce the temperature of the monitored areas, when the power supply controllers are turned off, the corresponding cooling devices are in sleep mode.

12. The temperature control system as claimed in claim 9, wherein the main controller comprises a plurality of interfaces and a display module, the plurality of interfaces are USB interfaces, and each interface is electrically connected to the corresponding temperature sensor, and the display module is one of the touch screen and the touch panel and is capable of inputting and presetting the predetermined temperature of the monitored areas.

13. The temperature control system as claimed in claim 12, wherein the main controller further comprises a signal processor electrically connected to the plurality of interfaces and the display module, the signal processor records and stores the predetermined temperature from the display module, and converts the analog signals from the temperature sensors into the current temperature values, and compares the current temperature values with the predetermined temperature.

14. The temperature control system as claimed in claim 13, wherein when the current temperature of any monitored area exceeds the predetermined temperature, the signal processor sends a first command signal to the corresponding power supply controller to activate the power supply controller, the power supply controller powers the corresponding cooling device to reduce the current temperature of the monitored area, when the current temperature of any monitored area is under the predetermined temperature, the signal processor sends a second command signal to the corresponding power supply controller to deactivate the power supply controller, the corresponding cooling device is powered off or placed in sleep mode to stop reducing the temperature of the monitored area.

15. A temperature control system used in a container data center (CDC), comprising:
a plurality of temperature sensors dividing the CDC into corresponding monitored areas, and measuring temperature parameters of the monitored areas;
a main controller electrically connected to the plurality of temperature sensors, the main controller storing a predetermined temperature and generating corresponding current temperature according to the temperature parameters;
a plurality of power supply controllers electrically connected to the main controller; and
a plurality of cooling devices, each cooling device electrically connected to the corresponding power supply controller, wherein the main controller compares the current temperature of each monitored area with the predetermined temperature to selectably turn the corresponding power supply controller on or off, when the current temperature exceeds the predetermined temperature, the signal processor controls to activate the corresponding power supply controller, the cooling device is turned on to reduce the current temperature of the monitored area, when the current temperature is under the predetermined temperature, the signal processor controls to deactivate the power supply controller, the cooling device is turned off to stop reducing the temperature of the monitored area.

16. The temperature control system as claimed in claim 15, wherein the plurality of cooling devices are cooling systems, and each power supply controller is electrically connected between the main controller and the corresponding cooling device, the power supply controller controls and provides operating voltage for the corresponding cooling device under the control of the main controller.

17. The temperature control system as claimed in claim 16, wherein when the power supply controllers are activated by the main controller, the power supply controllers provide the operating voltage for the corresponding cooling devices to activate the cooling devices, the cooling devices exchange and disperse heat to reduce the temperature of the monitored areas, when the power supply controllers are turned off, the corresponding cooling devices are in sleep mode.

18. The temperature control system as claimed in claim 15, wherein the main controller comprises a plurality of interfaces and a display module, the plurality of interfaces are USB interfaces, and each interface is electrically connected to the corresponding temperature sensor, and the display module is one of the touch screen and the touch panel and is capable of inputting and presetting the predetermined temperature of the monitored areas.

19. The temperature control system as claimed in claim 18, wherein the main controller further comprises a signal processor electrically connected to the plurality of interfaces and the display module, the signal processor records and stores the predetermined temperature from the display module, and converts the analog signals from the temperature sensors into the current temperature values, and compares the current temperature values with the predetermined temperature.

20. The temperature control system as claimed in claim 19, wherein when the current temperature of any monitored area exceeds the predetermined temperature, the signal processor sends a first command signal to the corresponding power supply controller to activate the power supply controller, the power supply controller powers the corresponding cooling device to reduce the current temperature of the monitored area, when the current temperature of any monitored area is under the predetermined temperature, the signal processor sends a second command signal to the corresponding power supply controller to deactivate the power supply controller, the corresponding cooling device is powered off or in sleep mode to stop reducing the temperature of the monitored area.
